(19) United States
(12) Patent Application Publication
(10) Pub. No.: US 2023/0199874 A1
(43) Pub. Date: Jun. 22, 2023

(54) CARRIER SELECTION FOR SIDELINK COMMUNICATIONS IN AN UNLICENSED SPECTRUM

(71) Applicant: QUALCOMM Incorporated, San Diego, CA (US)

(72) Inventors: Shuanshuan WU, San Diego, CA (US); Stelios STEFANATOS, San Diego, CA (US); Arthur GUBESKYS, San Diego, CA (US); Kapil GULATI, Belle Mead, NJ (US)

(21) Appl. No.: 17/995,973

(22) PCT Filed: Mar. 1, 2021
(86) PCT No.: PCT/US2021/020244

§ 371 Date: Oct. 11, 2022

(30) Foreign Application Priority Data
May 12, 2020 (GR) 20200100248

(51) Int. Cl. H04W 76/14; H04W 72/40

(52) U.S. Cl. CPC H04W 76/14; H04W 72/40

(57) ABSTRACT

Certain aspects of the present disclosure provide techniques for carrier selection for sidelink communications in an unlicensed spectrum. A method that may be performed by a first sidelink user equipment (UE) includes determining one or more carriers, from a set of configured carriers, in an unlicensed spectrum to use for communicating with a second sidelink UE and communicating with the second sidelink UE using the determined one or more carriers.

### CROSS-REFERENCE TO RELATED APPLICATION(S)

This application claims benefit of and priority to Greek Patent Application Serial No. 20200100248, filed May 12, 2020, which is hereby assigned to the assignee hereof and hereby expressly incorporated by reference herein in its entirety as if fully set forth below and for all applicable purposes.

### BACKGROUND

### Field of the Disclosure

Aspects of the present disclosure relate to wireless communications and, more particularly, to techniques for carrier selection for sidelink communications in an unlicensed spectrum.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Features of this disclosure provide advantages that include carrier selection for sidelink communications in an unlicensed spectrum.

Certain aspects of the subject matter described in this disclosure can be implemented in a method for wireless communication by a first sidelink user equipment (UE). The method generally includes determining one or more carriers, from a set of configured carriers, in an unlicensed spectrum to use for communicating with a second sidelink UE. The method generally includes communicating with the second sidelink UE using the determined one or more carriers.

Certain aspects of the subject matter described in this disclosure can be implemented in a method for wireless communication by a node (e.g., a base station (BS) or a roadside unit (RSU)). The method generally includes determining one or more carriers in an unlicensed spectrum for sidelink communications between at least a first UE and a second UE. The method generally includes transmitting an indication of the one or more carriers to at least one of the first UE, the second UE, or both.

Certain aspects of the subject matter described in this disclosure can be implemented in an apparatus for wireless communication. The apparatus generally includes at least one processor and a memory coupled to the at least one processor. The memory comprises code executable by the at least one processor to cause the apparatus to determine one or more carriers, from a set of configured carriers, in an unlicensed spectrum to use for communicating with a sidelink UE. The memory comprises code executable by the at least one processor to cause the apparatus to communicate with the sidelink UE using the determined one or more carriers.

Certain aspects of the subject matter described in this disclosure can be implemented in an apparatus for wireless communication. The apparatus generally includes at least one processor and a memory coupled to the at least one processor. The memory comprises code executable by the at least one processor to cause the apparatus to determine one or more carriers in an unlicensed spectrum for sidelink communications between at least a first UE and a second UE. The memory comprises code executable by the at least one processor to cause the apparatus to transmit an indication of the one or more carriers to at least one of the first UE, the second UE, or both.

Certain aspects of the subject matter described in this disclosure can be implemented in a computer readable medium storing computer executable code thereon for wireless communication. The computer executable code generally includes code for determining one or more carriers, from a set of configured carriers, in an unlicensed spectrum to use for communicating with a sidelink UE. The computer executable code generally includes code for communicating with the sidelink UE using the determined one or more carriers.

Certain aspects of the subject matter described in this disclosure can be implemented in a computer readable medium storing computer executable code thereon for wireless communication. The computer executable code generally includes code for determining one or more carriers in an unlicensed spectrum for sidelink communications between at least a first UE and a second UE. The computer executable code generally includes code for transmitting an indication of the one or more carriers to at least one of the first UE, the second UE, or both.

While aspects are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings.

FIG. 1 is a block diagram conceptually illustrating an example wireless communication network, in accordance with certain aspects of the present disclosure.

FIG. 2 is a block diagram conceptually illustrating a design of an example a base station (BS) and user equipment (UE), in accordance with certain aspects of the present disclosure.

FIG. 3 is an example frame format for certain wireless communication systems (e.g., new radio (NR)), in accordance with certain aspects of the present disclosure.

FIG. 4A and FIG. 4B show diagrammatic representations of example vehicle to everything (V2X) systems, in accordance with certain aspects of the present disclosure.

FIG. 5 is a flow diagram illustrating example operations for wireless communication by a first sidelink UE, in accordance with certain aspects of the present disclosure.

FIG. 6 illustrates carrier selection based on a carrier hopping rule, in accordance with certain aspects of the present disclosure.

FIG. 7 illustrates carrier selection based on another carrier hopping rule, in accordance with certain aspects of the present disclosure.

FIG. 8 is a flow diagram illustrating example operations for wireless communication by a node, in accordance with certain aspects of the present disclosure.

FIG. 9 is a call flow diagram illustrating example operations for carrier selection for sidelink communications in an unlicensed spectrum, in accordance with aspects of the present disclosure.

FIG. 10 is another call flow diagram illustrating example operations for carrier selection for sidelink communications in an unlicensed spectrum, in accordance with aspects of the present disclosure.

FIG. 11 illustrates a communications device that may include various components configured to perform operations for the techniques disclosed herein in accordance with aspects of the present disclosure.

FIG. 12 illustrates a communications device that may include various components configured to perform operations for the techniques disclosed herein in accordance with aspects of the present disclosure.

To facilitate understanding, identical reference numerals have been used, where possible, to designate identical elements that are common to the figures.

### DETAILED DESCRIPTION

Aspects of the present disclosure provide apparatus, methods, processing systems, and computer readable mediums for carrier selection for sidelink communications in an unlicensed spectrum.

In some systems, sidelink communications, such as cellular vehicle-to-anything (C-V2X) communications, may be deployed in an unlicensed band. The unlicensed spectrum may be shared by other technologies (e.g., Wifi). Due to the wide range of available unlicensed spectrum and with a limited capability, a sidelink user equipment (UE) may be incapable of monitoring all carriers/frequencies in the unlicensed spectrum.

The UE's burden of monitoring may be alleviated if the transmitting and receiving UEs have a common understanding of the carrier(s) used for communication; however, statically limiting sidelink communication to a specific unlicensed carrier may be inflexible and lead to sub-optimal performance. Thus, techniques for carrier selection for sidelink communications in an unlicensed spectrum are desirable.

Aspects of the present disclosure provide a flexible approach for determining carrier(s) to use for sidelink communication in unlicensed spectrum. In some examples, carrier selection in an unlicensed spectrum may be based on a carrier hopping rule. In some examples, carrier selection in unlicensed spectrum may be based on an indication from another node.

The following description provides examples of carrier selection in sidelink communication systems in unlicensed spectrum. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. The disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim.

### Example Wireless Communication Network

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth, millimeter wave (mmW) targeting high carrier frequency, massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe. NR supports beamforming and beam direction may be dynamically configured. MIMO transmissions with precoding may also be supported. MIMO configurations in the DL may support multiple transmit antennas with multi-layer DL transmissions. Multi-layer transmissions may be supported. Aggregation of multiple cells may be supported.

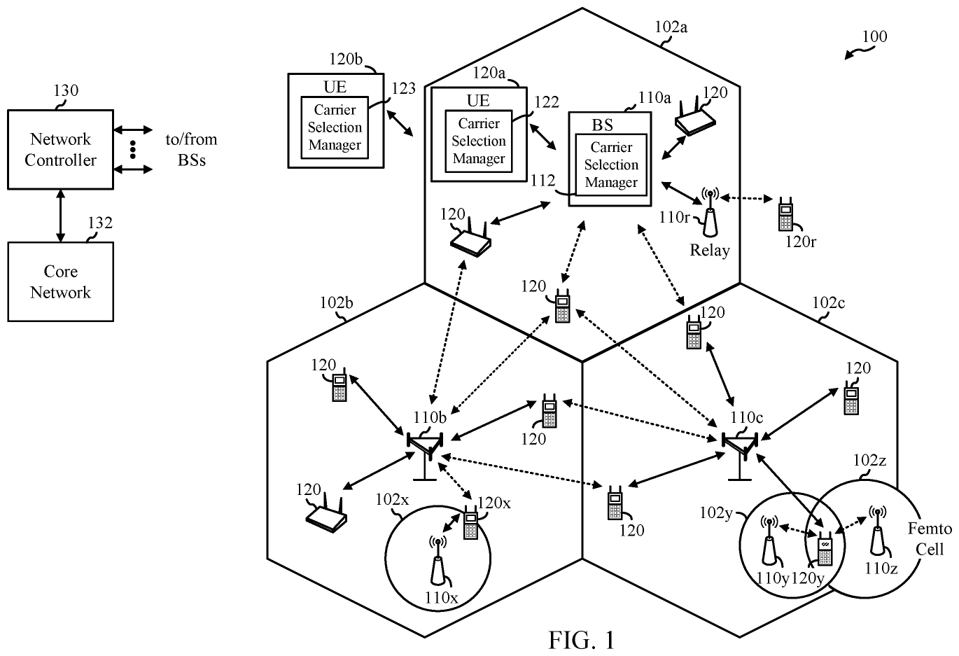

FIG. 1 illustrates an example wireless communication network 100 in which aspects of the present disclosure may be performed. For example, the wireless communication network 100 may be an NR system (e.g., a 5G NR network). As shown in FIG. 1, the wireless communication network 100 may be in communication with a core network 132. The core network 132 may in communication with one or more base station (BSs) 110a-z (each also individually referred to herein as BS 110 or collectively as BSs 110) and other network entities and/or user equipments (UEs) 120a-y (each also individually referred to herein as UE 120 or collectively as UEs 120) in the wireless communication network 100 via one or more interfaces.

According to certain aspects, the BSs 110 and UEs 120 may be configured for carrier selection in an unlicensed spectrum. In some examples, the UEs 120 may be configured for sidelink communications. As shown in FIG. 1, the BS 110a includes a carrier selection manager 112 that may be configured for carrier selection for sidelink communications in an unlicensed spectrum, in accordance with aspects of the present disclosure. As shown in FIG. 1, the UE 120a includes carrier selection manager 122 that may be configured for carrier selection for sidelink communications in an unlicensed spectrum, in accordance with aspects of the present disclosure. As shown in FIG. 1, the UE 120b includes carrier selection manager 123 that may be configured for carrier selection for sidelink communications in an unlicensed spectrum, in accordance with aspects of the present disclosure.

A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. ABS may support one or multiple cells.

The BSs 110 communicate with UEs 120 in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may be in communication with a set of BSs 110 and provide coordination and control for these BSs 110 (e.g., via a backhaul). In aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

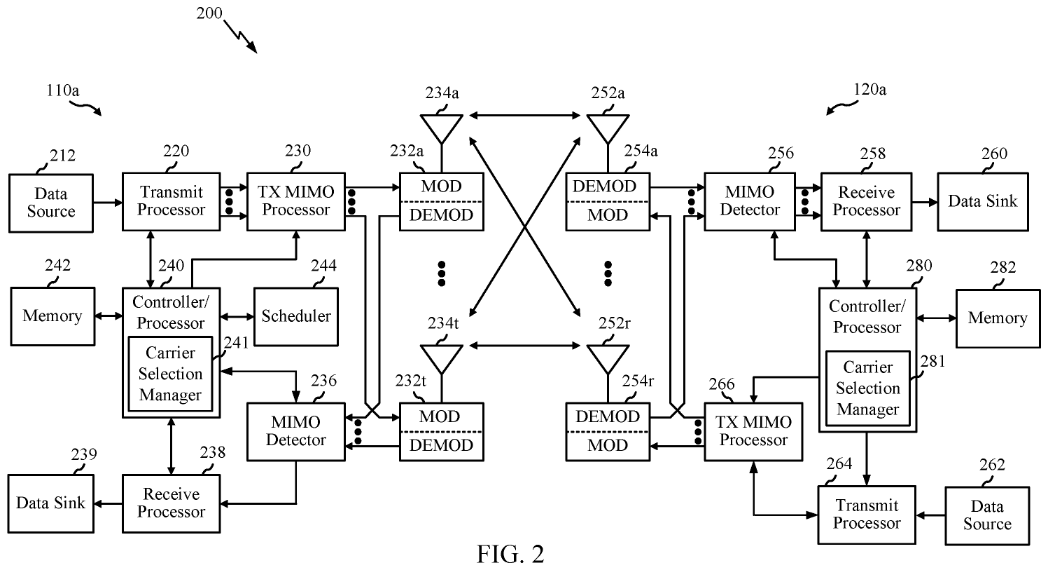

FIG. 2 illustrates example components of BS 110a and UE 120a (e.g., as shown in the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators in transceivers 232a-232t may be transmitted via the antennas 234a-234t, respectively.

At the UE 120a (or similarly in the UE 120b), the antennas 252a-252r may receive the downlink signals from the BS 110a and may provide received signals to the demodulators (DEMODs) in transceivers 254a-254r, respectively. Each demodulator may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink or sidelink, at UE 120a, a transmit processor 264 may receive and process data (e.g., for the physical uplink shared channel (PUSCH) or physical sidelink shared channel (PSSCH)) from a data source 262 and control information (e.g., for the physical uplink control channel (PUCCH) or physical sidelink control channel)) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM, etc.), and transmitted to the BS 110a (or to a sidelink UE 120b). At the BS 110a (or sidelink UE 120b), the uplink signals from the UE 120a may be received by the antennas 234, processed by the demodulators, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. For example, as shown in FIG. 2, the controller/processor 240 of the BS 110a has a carrier selection manager 241 that may be configured for carrier selection for sidelink communications in an unlicensed spectrum, according to aspects described herein. As shown in FIG. 2, the controller/processor 280 of the UE 120a has carrier selection manager 281 that may be configured for carrier selection for sidelink communications in an unlicensed spectrum, according to aspects described herein. Although shown at the controller/processor, other components of the UE 120a and BS 110a may be used to perform the operations described herein.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

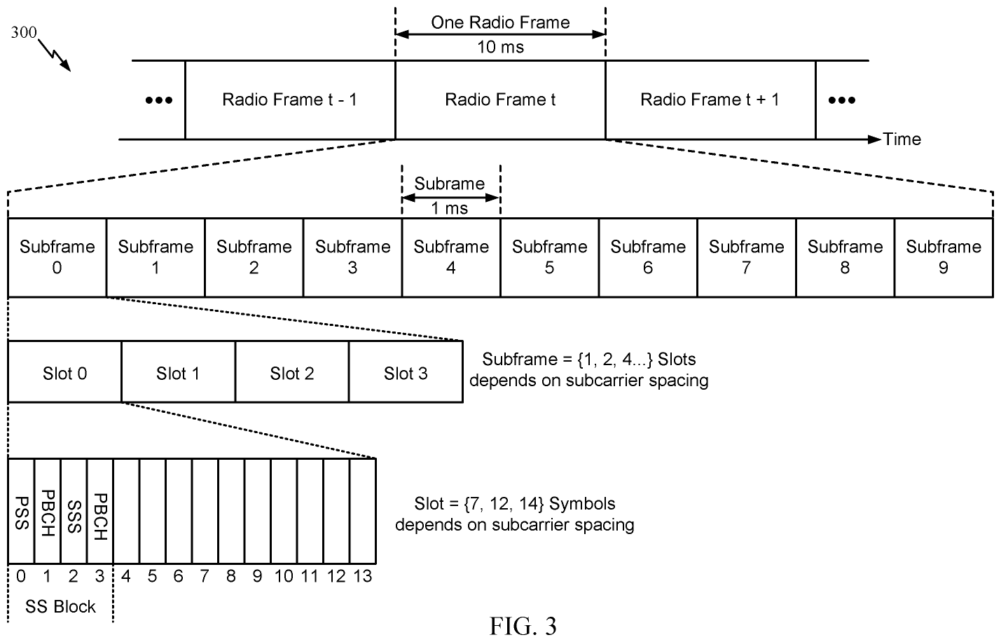

FIG. 3 is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots (e.g., 1, 2, 4, 8, 16, . . . slots) depending on the SCS. Each slot may include a variable number of symbol periods (e.g., 7, 12, or 14 symbols) depending on the SCS. The symbol periods in each slot may be assigned indices. A sub-slot structure is a transmit time interval having a duration less than a slot (e.g., 2, 3, or 4 symbols). Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

### Example Sidelink Communications in a Wireless Communication Network

The communication between user equipments (UE), such as the UEs 120 in the wireless communication network 100, and base stations (BSs), such as the BSs 110 in the wireless communication network 100, may be referred to as the access link. The access link may be provided via a Uu (e.g., cellular) interface. Communication between devices may be referred as the sidelink.

Two or more subordinate entities (e.g., UEs 120) may communicate with each other using sidelink signals. Real-world applications of such sidelink communications may include public safety, proximity services, UE-to-network relaying, vehicle-to-vehicle (V2V) communications, Internet of Everything (IoE) communications, Internet of Things (IoT) communications, mission-critical mesh, and/or various other suitable applications. A sidelink signal may be communicated from one subordinate entity (e.g., UE 120a) to another subordinate entity (e.g., another UE 120) without relaying that communication through the scheduling entity (e.g., UE 120 or BS 110), even though the scheduling entity may be utilized for scheduling and/or control purposes. In some systems, sidelink signals are communicated using a licensed spectrum (e.g., unlike wireless local area (WLAN) networks, which may use an unlicensed spectrum). One example of sidelink communication is PC5, for example, as used in V2V, LTE, and/or NR.

Various sidelink channels may be used for sidelink communications, including a physical sidelink discovery channel (PSDCH), a physical sidelink control channel (PSCCH), a physical sidelink shared channel (PSSCH), and a physical sidelink feedback channel (PSFCH). The PSDCH may carry discovery expressions that enable proximal devices to discover each other. The PSCCH may carry control signaling such as sidelink resource configurations and other parameters used for data transmissions, and the PSSCH may carry the data transmissions. The PSFCH may carry feedback such as CSI related to a sidelink channel quality.

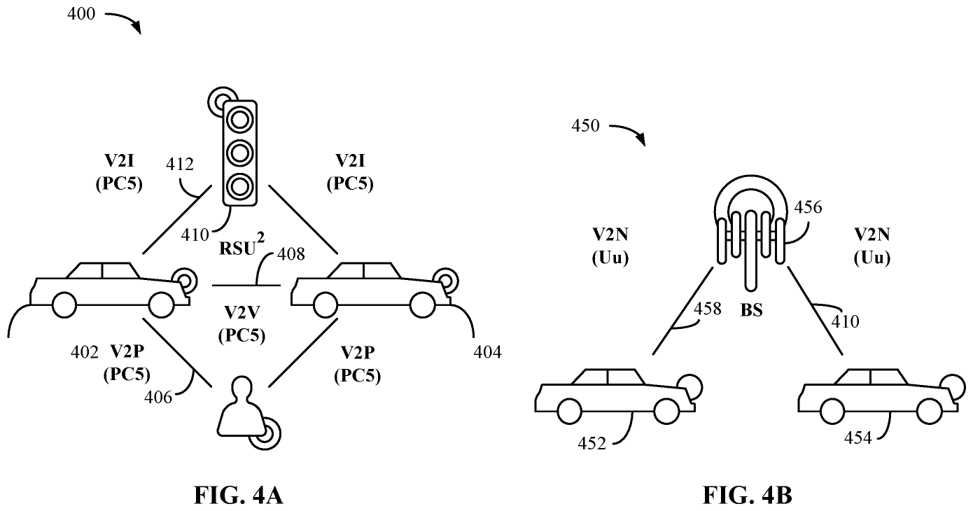

FIG. 4A and FIG. 4B show diagrammatic representations of example V2X systems, in accordance with some aspects of the present disclosure. For example, the vehicles shown in FIG. 4A and FIG. 4B may communicate via sidelink channels and may perform sidelink CSI reporting as described herein.

The V2X systems, provided in FIG. 4A and FIG. 4B provide two complementary transmission modes. A first transmission mode, shown by way of example in FIG. 4A, involves direct communications (for example, also referred to as side link communications) between participants in proximity to one another in a local area. A second transmission mode, shown by way of example in FIG. 4B, involves network communications through a network, which may be implemented over a Uu interface (for example, a wireless communication interface between a radio access network (RAN) and a UE).

Referring to FIG. 4A, a V2X system 400 (for example, including vehicle to vehicle (V2V) communications) is illustrated with two vehicles 402, 404. The first transmission mode allows for direct communication between different participants in a given geographic location. As illustrated, a vehicle can have a wireless communication link 406 with an individual (V2P) (for example, via a UE) through a PC5 interface. Communications between the vehicles 402 and 404 may also occur through a PC5 interface 408. In a like manner, communication may occur from a vehicle 402 to other highway components (for example, highway component 410), such as a traffic signal or sign (V2I) through a PC5 interface 412. With respect to each communication link illustrated in FIG. 4A, two-way communication may take place between elements, therefore each element may be a transmitter and a receiver of information. The V2X system 400 may be a self-managed system implemented without assistance from a network entity. A self-managed system may enable improved spectral efficiency, reduced cost, and increased reliability as network service interruptions do not occur during handover operations for moving vehicles. The V2X system 400 may be configured to operate in a licensed or unlicensed spectrum, thus any vehicle with an equipped system may access a common frequency and share information. Such harmonized/common spectrum operations allow for safe and reliable operation.

FIG. 4B shows a V2X system 450 for communication between a vehicle 452 and a vehicle 454 through a network entity 456. These network communications may occur through discrete nodes, such as a BS (e.g., the BS 110a), that sends and receives information to and from (for example, relays information between) vehicles 452, 454. The network communications through vehicle to network (V2N) links 458 and 410 may be used, for example, for long range communications between vehicles, such as for communicating the presence of a car accident a distance ahead along a road or highway. Other types of communications may be sent by the wireless node to vehicles, such as traffic flow conditions, road hazard warnings, environmental/weather reports, and service station availability, among other examples. Such data can be obtained from cloud-based sharing services.

Roadside units (RSUs) may also be utilized. An RSU may be used for V2I communications. In some systems, an RSU may act as a forwarding node to extend coverage for a UE. In some systems, an RSU may be co-located with a BS or may be standalone. RSUs can have different classifications. For example, RSUs can be classified into UE-type RSUs and Micro NodeB-type RSUs. Micro NB-type RSUs have similar functionality as the Macro eNB/gNB. The Micro NB-type RSUs can utilize the Uu interface. UE-type RSUs can be used for meeting tight quality-of-service (QoS) requirements by minimizing collisions and improving reliability. UE-type RSUs may use centralized resource allocation mechanisms to allow for efficient resource utilization. Critical information (e.g., such as traffic conditions, weather conditions, congestion statistics, sensor data, etc.) can be broadcast to UEs in the coverage area. Relays can re-broadcast critical information received from some UEs. UE-type RSUs may be a reliable synchronization source.

Aspects of the disclosure relate to sidelink communications, such as cellular-vehicular-to-anything (C-V2X) communications. C-V2X offers vehicles low-latency V2V, V2I, and V2P communication. C-V2X networks can operate without cellular infrastructure support. For example, C-V2X communication allows direct communication between two UE devices, without transmissions through the BS, functioning by continuous monitoring and decoding of other UE devices. In C-V2X, vehicles can autonomously select their radio resources. For example, the vehicles may select resources, such as semi-persistent scheduling (SPS) resources, according to an algorithm. The algorithm may be a resource allocation algorithm specified by the 3GPP wireless standards.

Current 3GPP sidelink (e.g., for C-V2X) design targets deployment in a licensed spectrum, either by deployment in a shared, licensed cellular band or by deployment in a dedicated intelligent transportation system (ITS) spectrum. In the licensed spectrum, the spectrum may be assigned exclusively to operators for independent usage. Licensed spectrum may either be shared or dedicated. Shared licensed spectrums provide bandwidth up to a specified level and the bandwidth is shared among all subscribers. Therefore, in a licensed cellular band, a C-V2X system shares uplink spectrum in the cellular network. On the other hand, dedicated internet spectrum provides guaranteed bandwidth at all times, thereby providing spectrum exclusivity when the C-V2X design is deployed in a dedicated ITS spectrum.

ITSs support a wide variety of safety-critical and traffic-efficient applications. Some countries and regions have allocated spectrums around 5.9 GHz to V2X communications; however, sufficient amount of dedicated spectrums may not be guaranteed in all locations due to spectrum scarcity. Spectrum scarcity has emerged as a primary problem encountered when trying to launch new wireless services in some regions. The effects of this scarcity have led some locations to allocate spectrums for LTE V2X only, leaving allocated spectrum for NR V2X either unavailable or insufficient in supporting advanced V2X applications. NR (e.g., 3GPP Release 16 5G NR) includes specification for 5G NR C-V2X which targets advanced V2X use cases, such as autonomous driving. 5G NR C-V2X goes beyond technology that targets basic safety, by adding direct multicast communication technology for advanced safety, increased situational awareness, energy savings, and faster travel time.

In some cases, C-V2X communications are deployed in an unlicensed spectrum. Unlicensed spectrum refers to frequency bands that are not in licensed spectrum. In unlicensed spectrum, the spectrum may be available for non-exclusive usage subject to some regulatory constraints (e.g., restrictions in transmission power). Technical rules may be specified for both hardware and deployment methods of radio systems in unlicensed spectrum, such that the frequency band is open for shared use by an unlimited number of unaffiliated users.

In an unlicensed spectrum, a minimum channel bandwidth may be specified in accordance with regional regulations, and any technological device may transmit in a bandwidth equal to or greater than the specified minimum channel bandwidth. For example, in some regions the minimum channel bandwidth may be set at 5 megahertz (MHz). There exists a wide range of unlicensed spectrums available, e.g., from 5 gigahertz (GHz) to 6 GHz (e.g., Unlicensed National Information Instructure 3 (U-NII-3) operating between 5.725 GHz and 5.850 GHz or U-NII-4 operating between 5.850 GHz and 5.925 GHz). As used herein, the 5 GHz unlicensed spectrum, also referred to as the U-NII band, comprises the frequency range between 5150 MHz and 5925 MHz. The 6 GHz unlicensed spectrum potentially comprises the frequency range from 5925 MHz up to 7125 MHz.

In contrast with most licensed assignments of spectrum use rights, devices or systems operating on an unlicensed basis do not have regulatory protection against interference from other licensed or unlicensed users in the frequency band. The unlicensed spectrum may be utilized by wireless local area networks (WLAN), such as the ones that are based on IEEE 801.11a/g/n/ac technologies, which are also referred to as Wi-Fi systems. For example, a Wi-Fi device may transmit in a channel bandwidth of 20 MHz, 80 MHz, 160 MHz, or any other channel bandwidth above 5 MHz.

Sidelink (e.g., C-V2X) communications deployed in an unlicensed spectrum may operate in either a distributed or a centralized manner. In distributed C-V2X, UEs communicate independently without the assistance of a central node (e.g., a BS) scheduling transmissions between the UEs. In centralized C-V2X, a central node controls and assists with sidelink communications.

Although continuous monitoring may help to effectuate sidelink communication, UEs in an unlicensed spectrum may be incapable of meeting these demands. Continuous monitoring of all carriers/frequencies for potential sidelink transmission may be an unrealistic expectation when a UE is deployed in an unlicensed spectrum due to the wide range of available spectrums (e.g., U-NII-3 or U-NII-4) in the unlicensed band coupled with the frequency band's limited capability.

Statically limiting C-V2X communication to a specific unlicensed carrier may lead to sub-optimal performance, such as an increased probability of interference with other technologies within the frequency band.

Accordingly, what is needed are techniques and apparatus for carrier selection when C-V2X communications are deployed in an unlicensed spectrum.

### Example Carrier Selection for Sidelink Communications in an Unlicensed Spectrum

Aspects of the present disclosure provide enhancements for carrier selection for sidelink communications in an unlicensed spectrum. Techniques are provided for determining a single carrier frequency, or a limited number of carrier frequencies (e.g., also referred to as carriers), from a set of configured carriers in an unlicensed spectrum, which may be used for sidelink communication. The techniques may be used for cellular vehicle-to-everything (C-V2X) communications in the unlicensed spectrum. The techniques may provide for flexible carrier selection that is known to both transmitting and receiving sidelink devices. In some examples, the carrier selection is based on a carrier hopping rule. In some examples, the carrier selection is indicated by a node.

Capability of a user equipment (UE) to transmit and receive in a limited number of carriers, in an unlicensed spectrum, known to all UEs is beneficial to reduce the UE's burden of monitoring all carriers within in the unlicensed band. For example, this burden may be alleviated where UEs have common understanding of carrier(s) used for C-V2X communication.

An unlicensed spectrum may include a number of carriers (e.g., carrier frequencies). A set of the carriers may be configured (e.g., by higher layer signaling) or preconfigured (e.g., hardcoded or specified in a wireless standard) for sidelink communications. The set of configured carriers may be candidate carriers for a UE to use and/or to monitor for sidelink communication.

According to certain aspects, a UE can determine a subset (e.g., one or more) of the configured carriers to use and/or to monitor for sidelink communication in an unlicensed spectrum.

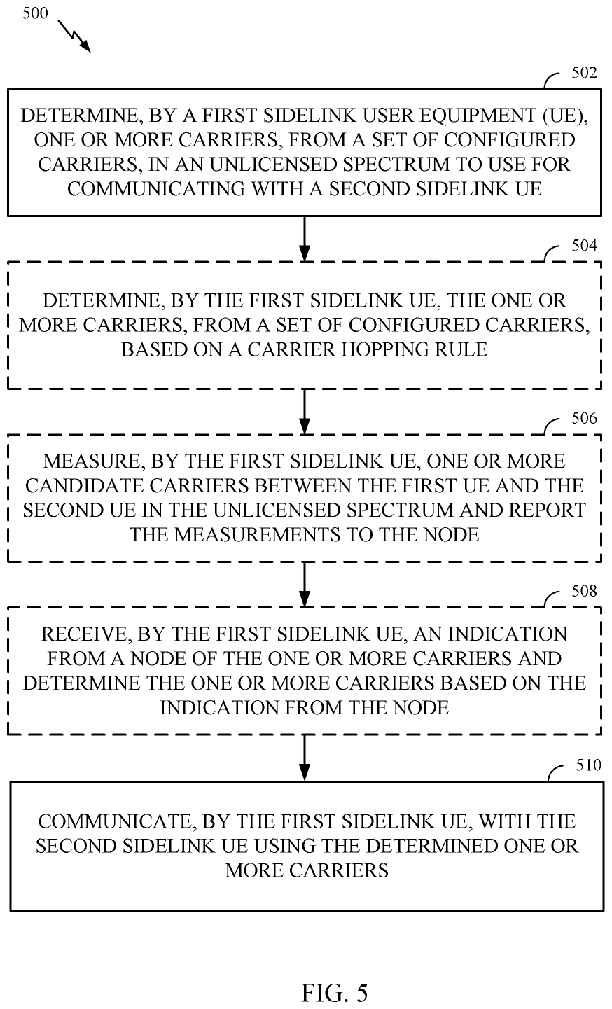

FIG. 5 is a flow diagram illustrating example operations 500 for wireless communication, in accordance with certain aspects of the present disclosure. The operations 500 may be performed, for example, by a first sidelink UE (e.g., the UE 120a and/or the UE 120b in the wireless communication network 100). The operations 500 may be implemented as software components that are executed and run on one or more processors (e.g., controller/processor 280 of FIG. 2). Further, the transmission and reception of signals by the UE in operations 500 may be enabled, for example, by one or more antennas (e.g., antennas 252 of FIG. 2). The transmission and/or reception of signals by the UE may be implemented via a bus interface of one or more processors (e.g., controller/processor 280) obtaining and/or outputting signals.

The operations 500 may begin, at 502, by determining one or more carriers, from a set of configured carriers, in an unlicensed spectrum to use for communicating with a second sidelink UE. The first sidelink UE and the second sidelink UE in the operations of 500 may be vehicular UEs.

In some examples, determining the one or more carriers in the unlicensed spectrum (at 502) includes determining the one or more carriers, from the set of configured carriers, based on a carrier hopping rule (optionally at 504). The carrier hopping rule may be common to the first sidelink UE and the second sidelink UE. In some examples, the first sidelink UE determines a carrier to use for communicating for a preconfigured duration of activation. After the preconfigured duration of activation, the first sidelink UE may determine another carrier to use for another preconfigured duration of activation. The preconfigured duration of activation may be associated with an index of the carrier, or may have a common value to the carrier. The carrier hopping rule may be a function of a time parameter, such as a frame number, a subframe number, a slot number, or an absolute time.

In some examples, the first sidelink UE may determine one carrier index directly from a mapping of the time parameter to the carrier index. In some examples, the first sidelink UE determines one carrier index based on a function involving a current frame number, a length of the frame, and a number of configured carriers. The first sidelink UE may generate a pseudo-random number from the time parameter using the time parameter as an input for a pseudo-random number generator. The first sidelink UE may determine an activated carrier index from the generated pseudo-random number. For example, the first sidelink UE may generate the pseudo-random number based on a function of the current frame number and a preconfigured duration for using the determined carrier. The first sidelink UE may determine the activated carrier index based on a function of the current frame number and a number of configured carriers.

In some examples, determining the one or more carriers in the unlicensed spectrum (at 502) includes determining the one or more carriers based on receiving an indication of the one or more carriers from a node. One or multiple UEs communicating on the sidelink (e.g., the first sidelink UE) may measure one or more candidate carriers in the unlicensed spectrum and report the measurements to the node (at 506). The indication of the one or more carriers from the node may be received in response to the reporting (at 508).

The node in the operations of 500 may be a BS and the signal may be received on an access link. The node in the operations of 500 may be a roadside unit (RSU) and the signal may be received on a sidelink. For example, the signal may be received on the sidelink via a predetermined carrier in an intelligent transport system (ITS) spectrum or may be broadcast on all configured carriers.

At 510, the first sidelink UE communicates with the second sidelink UE using the determined one or more carriers.

According to certain aspects, the carrier hopping rule(s) is common to both transmitting and receiving UEs (e.g., all UEs in an unlicensed spectrum). The UEs can use the common carrier hopping rule(s) to determine the same carrier(s) for transmitting (by the transmitting UEs) and monitoring (by the receiving UEs). Determination of the same candidate carrier enables the UEs to transmit and receive in the same carrier(s) at a specific time, facilitating sidelink communication. Because the carrier(s) is known, the receiving UEs can monitor only a subset of the configured carriers.

In some aspects, the carrier hopping rule is defined as a function of time. For example, the carrier hopping may be based on a frame number (e.g., an index number of a radio frame), a subframe number (e.g., an index number of a subframe), a slot number (e.g., an index number of a slot), or an absolute time. The time parameter can be determined based on synchronization. The UE can determine the time parameter by acquiring coordinated universal time (UTC) from a global navigation satellite system (GNSS) signal. The UE can determine the time parameter from another device via a sidelink signal (e.g., sidelink synchronization signal block) and/or via an access/cellular link signal (e.g., a downlink or broadcast synchronization signal).

As used herein, the frame number, subframe number, and/or slot number may refer to the LTE/NR radio frame/slot structure (e.g., as shown in FIG. 3). A radio frame indexing cycle may have 1,024 frames where the length of each radio frame is 10 milliseconds (ms). A radio frame may consist of 10 subframes (e.g., 1 ms each subframe). Each subframe (and frame) may consist of a number of slots that depends on the subcarrier spacing (SCS).

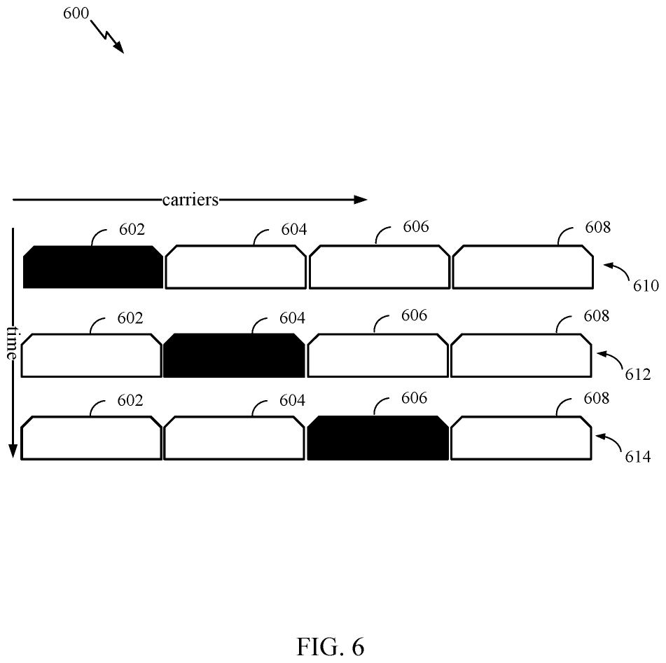

A carrier active for sidelink communication in the unlicensed spectrum may be determined directed from the time parameter. In this example, carriers may be determined in a sequential manner. For example, each sequential time interval an adjacent carrier may be activated (and determined). As shown in FIG. 6, in a first time interval 610, the carrier 602 is active; in the next time interval 612, the carrier 604 is active; in the time interval 614, the carrier 606 is active; and so on. The active carrier can be determined from a mapping of the time parameter to the carrier index. In an example, the activated carrier index, I_{carrier} may be determined from

$${l}_{carrier} = mod ( \vert \frac{{i}_{f} * {t}_{f}}{{t}_{a c t}} \vert , {N}_{carrier} ) ,$$

where i_{f} is the current frame number and t_{f} is the length of the current frame, and N_{carrier} is the number of configured carriers.

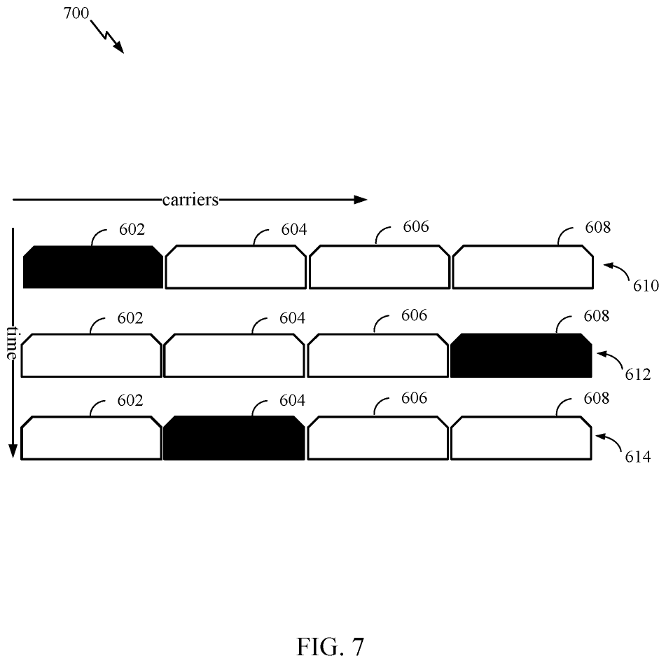

In some examples, a single carrier may be activated for sidelink communication at a given time. The duration of activation may be a pre-configured value. The duration of activation may be defined by the carrier hopping rule. The duration of activation may be common irrespective of the index of each carrier. In the illustrative example in FIG. 6 and FIG. 7, the duration of activation of a carrier may be (pre)configured to be t_{act}=640 ms (e.g., 16 activation periods in a frame cycle) and the number of candidate carriers pre-configured for C-V2X communication, N_{carrier}, is 4, with carriers 602, 604, 606, and 608 having indexes 0, 1, 2, and 3, respectively.

As shown in FIG. 6, candidate carrier 604 may be activated after the duration of activation 610 has passed for carrier 602 and carrier 606 may be activated after the duration of activation 612 has passed for carrier 604. Accordingly, activated carriers may be determined in a sequential manner. For example, candidate carrier 602 is activated for a first duration 610, candidate carrier 604 is activated for a second duration 612, and candidate carrier 606 is activated for a third duration 614.

According to certain aspects, the active carrier for sidelink communication may be determined indirectly from the time parameter. For randomized carrier selection, a pseudo-random number may generated based on the time parameter. The pseudo-random number may be generated based at least on the current frame number, i_{f}, or based on the current frame number and the duration of activation,

$$\frac{{i}_{f}}{{t}_{a c t}} .$$

The same pseudo-random number may be generated every n_{act} frames. The activated carrier index may be determined from the generated pseudo-random number.

In some examples, a decimal value of the sequence is used to determine the pseudo-random number for determining the carrier index. Pseudo-random sequence generation may use a function to generate a pseudo-random integer. The function may be a gold-sequence generator function or a M-sequence generation function. The time parameter may be used to initialize the sequence generator function.

The duration for activation of each of the carriers, n_{act}, may be a configured value (e.g., RRC semi-statically configured or dynamically configured value) or preconfigured value (e.g., a hardcoded value or value specified in a wireless standard). The value may be defined by the carrier hopping rule. The value may be a common value irrespective of the index of each carrier. The activated carrier index may be determined by a function, such as the function I_{carrier}=mod(PN_{if}, N_{carrier}), where PN_{if} is the pseudo-random number generated in the current frame i_{f}.

As shown in FIG. 7, using the pseudo-random number, the selected carriers may be randomized across time. For example, candidate carrier 602 may be activated for a first duration 610, candidate carrier 608 may be activated for a second duration 612, and candidate carrier 604 may be activated for a third duration 614, as shown in FIG. 7.

As used herein, duration of activation (e.g., also referred to as activation period) may vary among candidate carriers in unlicensed spectrum. Each activation period may include larger or smaller rates (e.g., slot/ms) for carrier hopping.

According to certain aspects, a node (e.g., BS or RSU) may assist a UE in determining one or more carriers in the unlicensed spectrum. UEs communicating in sidelink may receive signaling from other nodes indicating the one or more carriers for the sidelink communication in the unlicensed spectrum.

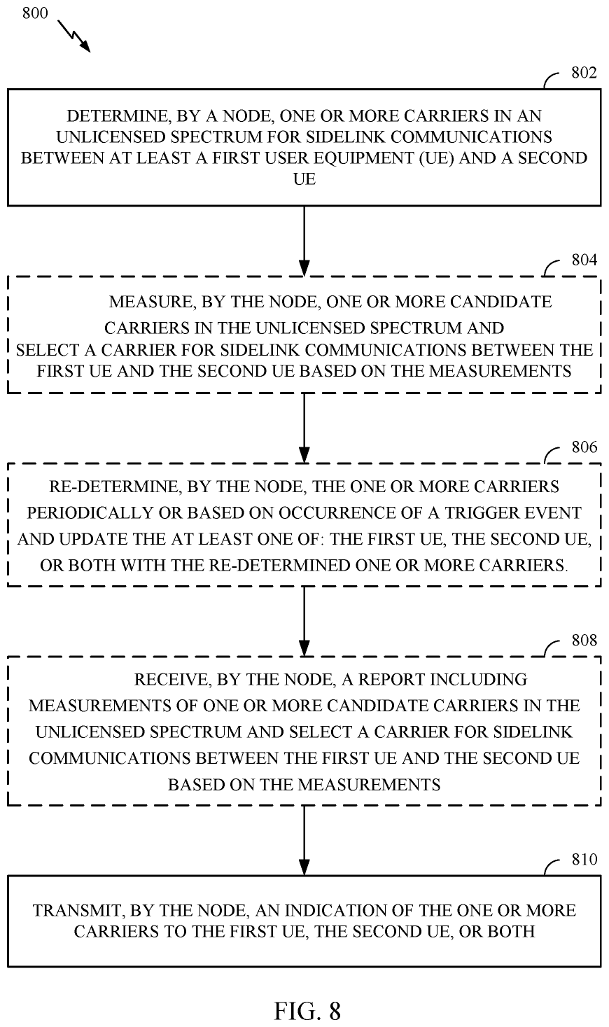

FIG. 8 is a flow diagram illustrating example operations 800 for wireless communication, in accordance with certain aspects of the present disclosure. The operations 800 may be performed, for example, by a node (e.g., the BS 110a in the wireless communication network 100 or an RSU). The operations 800 may be complimentary to the operations 500 performed by the UE. The operations 800 may be implemented as software components that are executed and run on one or more processors (e.g., controller/processor 240 of FIG. 2). Further, the transmission and reception of signals by the BS in operations 800 may be enabled, for example, by one or more antennas (e.g., antennas 234 of FIG. 2). In certain aspects, the transmission and/or reception of signals by the node may be implemented via a bus interface of one or more processors (e.g., controller/processor 240) obtaining and/or outputting signals.

The operations 800 may begin, at 802, by determining one or more carriers in an unlicensed spectrum for sidelink communications between at least a first UE and a second UE. In some examples, at 804, the node measures one or more candidate carriers in the unlicensed spectrum and selects a carrier for sidelink communications between the first UE and the second UE based on the measurements. For example, the node may measure at least one of an interference level, an energy level, a congestion level, and/or an occupancy level of a sidelink between the first UE and the second UE. In some cases, at 806, the node periodically re-determines and updates the one or more carriers or re-determines and updates the one or more carriers based on occurrence of a trigger event. In some examples, at 808, the node receives a report including measurements of one or more candidate carriers, between the first UE and the second UE, in the unlicensed spectrum and selects a carrier for sidelink communications between the first UE and the second UE based on the measurements.

At 810, the node transmits an indication of the one or more carriers to the first UE, the second UE, or both.

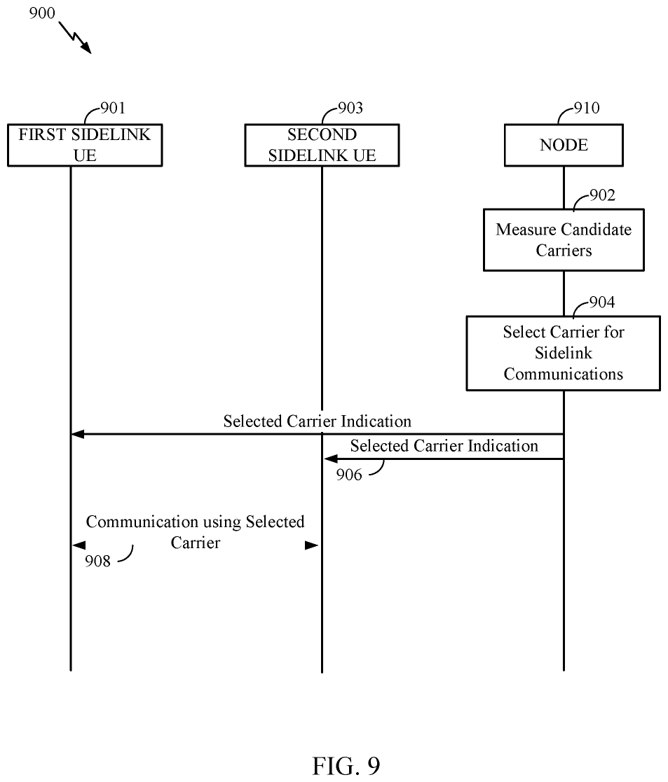

FIG. 9 is a call flow illustrating example operations 900 for carrier selection in an unlicensed spectrum in which the node measures the sidelink carriers for carrier selection, in accordance with aspects of the disclosure. A number of unlicensed carriers may be configured or preconfigured for sidelink communications between a first sidelink UE 901 and a second sidelink UE 903. As shown in FIG. 9, a node 910 (e.g., a BS or an RSU) may determine candidate carriers in an unlicensed spectrum for sidelink communications between the first sidelink UE 901 and the second sidelink UE 903. At 902, the node 910 measures candidate carriers between the first sidelink UE 901 and the second sidelink UE 903 in the unlicensed spectrum. The measurement by the node 910 may indicate an interference level, an energy level, a congestion level, and/or an occupancy level of each or some of the unlicensed carriers between the first UE 901 and the second sidelink UE 903. At 904, based on the measurement(s) of the carriers, the node 910 selects a carrier for sidelink communication between the first sidelink UE 901 and the second sidelink UE 903. For example, the node 910 may select the carrier with the least/lowest interference. At 906, the node 910 signals the selected carrier indication to the first sidelink UE 901 and the second sidelink UE 903. At 908, the selected carrier is used for sidelink communication between the first sidelink UE 901 and second sidelink UE 903. The selected carrier ensures that in C-V2X communications all UEs will transmit and receive in the same candidate carrier(s).

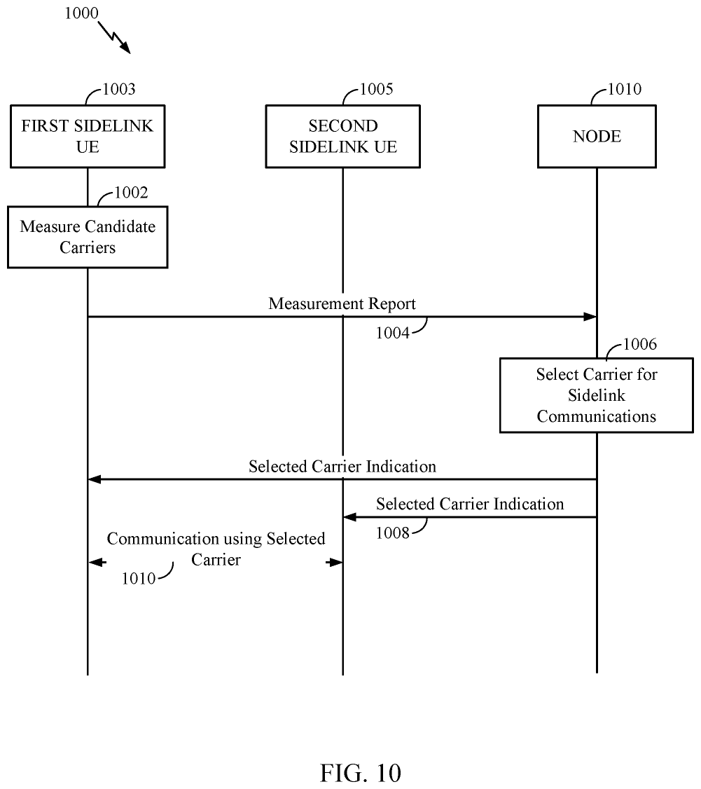

FIG. 10 is a call flow illustrating example operations 1000 for carrier selection in an unlicensed spectrum in which the UE(s) measure the sidelink carriers and report the measurements to the node for the carrier selection, in accordance with aspects of the disclosure.

As shown in FIG. 10, UEs may measure the candidate carriers in the unlicensed spectrum. At 1002, a first sidelink UE 1003 communicating on sidelink in the unlicensed spectrum measures part or all of the candidate unlicensed carriers. At 1004, the first sidelink UE 1003 reports the measurement to a node 110 (e.g., a BS or RSU). Based on the reported measurements, the node 1010 selects a carrier for sidelink communication, at 1006. The node 1010 signals an indication of the selected carrier to the first sidelink UEs 1003 and the second sidelink UE 1005, at 1008. The first sidelink UE 1003 and the second sidelink UE 1005 use the indicated carrier for sidelink communication, at 1010.

The indication of the selected carrier may be transmitted by a BS over an access link on a Uu interface. The indication of the selected carrier by be transmitted by an RSU via a predetermined carrier in an ITS spectrum. The indication of the selected carrier may be broadcast on all configured candidate carriers.

According to certain aspects, the node may periodically re-determine and update the active candidate carrier. If the carrier observed by the node does not change over a period of time, the node may not send an indication. However, the elongated time period may cause the UE to miss the carrier configuration because it has not received a new indication from the node for an extended period of time. Thus, even when the carrier is not changed, may send an indication to the UEs in sidelink periodically for the purpose of ensuring that carrier configuration is received by the UEs.

According to certain aspects, the node (e.g., BS or RSU) may re-determine and update the active carrier based on the occurrence of a trigger event. A triggering event may occur when the node measures a new carrier and the difference between the measurement on a new carrier and the current carrier is greater than a threshold. The node may measure an energy level measurement, such as decibel-milliwatts (dBm) or decibel-milliwatts/hertz (dBM/Hz). If the difference of the energy level measurement of a new carrier by the node and the energy level on another carrier is larger than a threshold, then the node may be triggered to update the activated carrier. The threshold energy level difference may be configured or preconfigured.

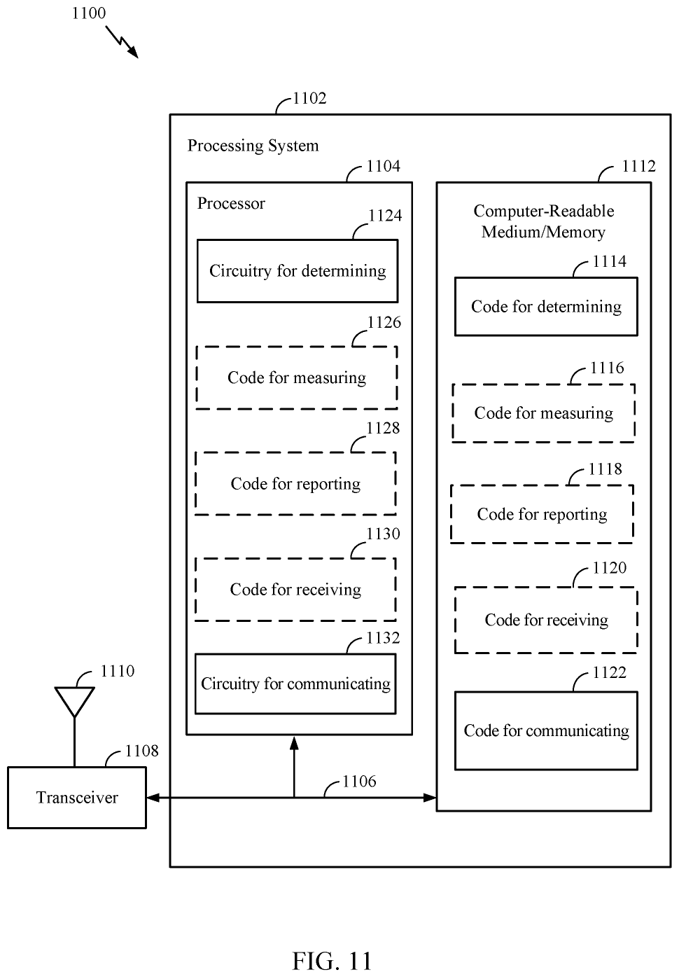

FIG. 11 illustrates a communications device 1100 that may include various components (e.g., corresponding to means-plus-function components) configured to perform operations for the techniques disclosed herein, such as the operations illustrated in FIG. 5. The communications device 1100 includes a processing system 1102 coupled to a transceiver 1108 (e.g., a transmitter and/or a receiver). The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes a processor 1104 coupled to a computer-readable medium/memory 1112 via a bus 1106. In certain aspects, the computer-readable medium/memory 1112 is configured to store instructions (e.g., computer-executable code) that when executed by the processor 1104, cause the processor 1104 to perform the operations illustrated in FIG. 5, or other operations for performing the various techniques discussed herein for carrier selection when C-V2X communications are deployed in an unlicensed spectrum. In certain aspects, computer-readable medium/memory 1112 stores code 1114 for determining; code 1116 for measuring; code 1118 for reporting; code 1120 for receiving; and/or code 1116 for communicating, in accordance with aspects of the present disclosure. In certain aspects, the processor 1104 has circuitry configured to implement the code stored in the computer-readable medium/memory 1112. The processor 1104 includes circuitry 1124 for determining; circuitry 1126 for measuring; circuitry 1128 for reporting; circuitry 1130 for receiving; and/or circuitry 1132 for communicating, in accordance with aspects of the present disclosure.

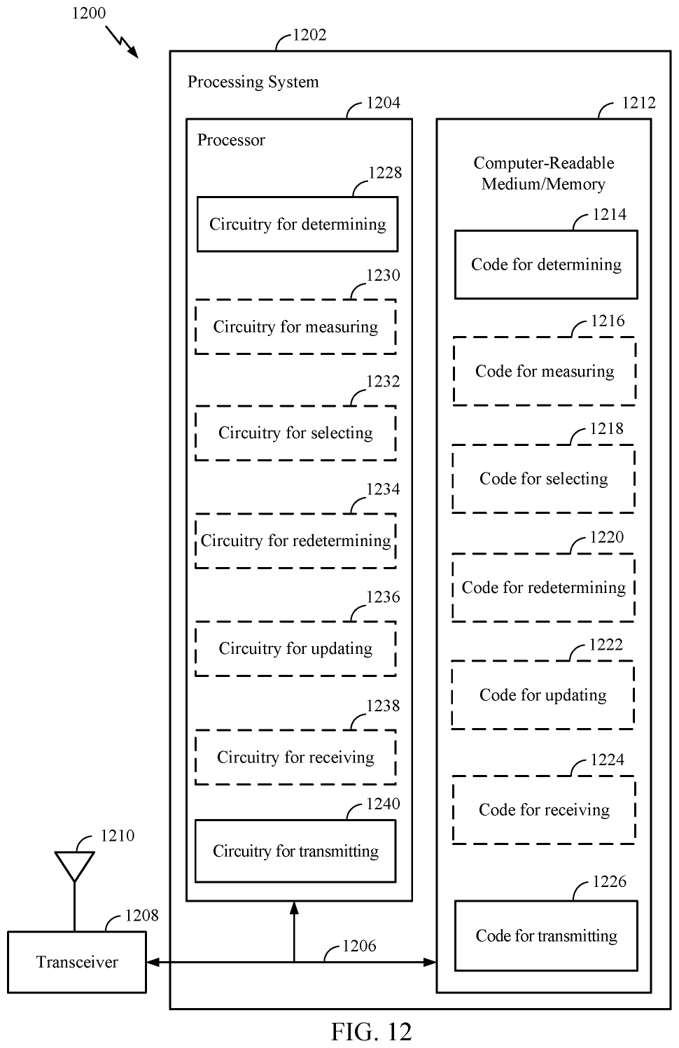

FIG. 12 illustrates a communications device 1200 that may include various components (e.g., corresponding to means-plus-function components) configured to perform operations for the techniques disclosed herein, such as the operations illustrated in FIG. 8. The communications device 1200 includes a processing system 1202 coupled to a transceiver 1208 (e.g., a transmitter and/or a receiver). The transceiver 1208 is configured to transmit and receive signals for the communications device 1200 via an antenna 1210, such as the various signals as described herein. The processing system 1202 may be configured to perform processing functions for the communications device 1200, including processing signals received and/or to be transmitted by the communications device 1200.

The processing system 1202 includes a processor 1204 coupled to a computer-readable medium/memory 1212 via a bus 1206. In certain aspects, the computer-readable medium/memory 1212 is configured to store instructions (e.g., computer-executable code) that when executed by the processor 1204, cause the processor 1204 to perform the operations illustrated in FIG. 8, or other operations for performing the various techniques discussed herein for carrier selection when C-V2X communications are deployed in an unlicensed spectrum. In certain aspects, computer-readable medium/memory 1212 stores code 1214 for determining; code 1216 for measuring; code 1218 for selecting; code 1220 for re-determining; code 1222 for updating; code 1224 for receiving; and/or code 1226 for transmitting, in accordance with aspects of the disclosure. In certain aspects, the processor 1204 has circuitry configured to implement the code stored in the computer-readable medium/memory 1212. The processor 1204 includes circuitry 1228 for determining; circuitry 1230 for measuring; circuitry 1232 for selecting; circuitry 1234 for re-determining; circuitry 1236 for updating; circuitry 1238 for receiving; and/or circuitry 1240 for transmitting, in accordance with aspects of the present disclosure.

### Example Aspects

In addition to the various aspects described above, the aspects can be combined. Some specific combinations of aspects are detailed below:

Aspect 1: A method for wireless communications by a first sidelink user equipment (UE), comprising: determining one or more carriers, from a set of configured carriers, in an unlicensed spectrum to use for communicating with a second sidelink UE; and communicating with the second sidelink UE using the determined one or more carriers.

Aspect 2: The method of aspect 1, wherein the determining the one or more carriers, from the set of configured carriers, in the unlicensed spectrum comprises: determining the one or more carriers, from the set of configured carriers, based on a carrier hopping rule.

Aspect 3: The method of aspect 2, wherein the carrier hopping rule is common to the first sidelink UE and the second sidelink UE.

Aspect 4: The method of any of aspects 2-3, wherein the determining the one or more carriers, from the set of configured carriers, in the unlicensed spectrum comprises: determining a first carrier to use for communicating for a first preconfigured duration of activation; and determining a second carrier to use for a second preconfigured duration of activation, after the first preconfigured duration of activation.

Aspect 5: The method of aspect 4, wherein the preconfigured duration of activation is associated with a carrier index.

Aspect 6: The method of any of aspects 2-5, wherein the carrier hopping rule is a function of a time parameter.

Aspect 7: The method of aspect 6, wherein the time parameter comprises a frame number, a subframe number, a slot number, or an absolute time.

Aspect 8: The method of any of aspects 6-7, wherein determining the one or more carriers, from the set of configured carriers, based on the carrier hopping rule comprises: determining one carrier index of one of the configured carriers directly from a mapping of the time parameter to the carrier index.

Aspect 9: The method of any of aspects 6-8, wherein determining the one or more carriers, from the set of configured carriers, based on the carrier hopping rule comprises: determining one carrier index of one of the configured carriers based on a function involving a current frame number, a length of the current frame, and a number of carriers in the set of configured carriers.

Aspect 10. The method of any of aspects 6-9, wherein determining the one or more carriers, from the set of configured carriers, based on the carrier hopping rule comprises: generating a pseudo-random number from the time parameter using the time parameter as an input for a pseudo-random number generator; and determining a carrier index of one of the configured carriers from the generated pseudo-random number.

Aspect 11: The method of aspect 10, wherein generating the pseudo-random number from the time parameter comprises: generating the pseudo-random number based on a function of a current frame number and a preconfigured duration of activation.

Aspect 12: The method of any of aspects 10-11, wherein determining the carrier index of one of the configured carriers from the generated pseudo-random number comprises: determining the carrier index based on a function of a current frame number and a number of carriers in the set of configured carriers.

Aspect 13: The method of any of any of aspect 1, further comprising: receiving an indication from a node of the one or more carriers, wherein determining the one or more carriers, from the set of configured carriers, in the unlicensed spectrum comprises determining the one or more carriers based on the indication from the node.

Aspect 14: The method of aspect 13, further comprising: measuring one or more candidate carriers between the first UE and the second UE in the unlicensed spectrum; and reporting the measurements to the node, wherein the indication of the one or more carriers from the node is received in response to the reporting.

Aspect 15: The method of any of aspects 13-14, wherein: the node is a base station (BS) and the indication is received on an access link; or the node is a roadside unit (RSU) and the indication is received on a sidelink via a predetermined carrier in an intelligent transport system (ITS) spectrum or is broadcast on all of the configured carriers.

Aspect 16: A method for wireless communications by a node, comprising: determining one or more carriers in an unlicensed spectrum for sidelink communications between at least a first user equipment (UE) and a second UE; and transmitting an indication of the one or more carriers to the first UE, the second UE, or both.

Aspect 17: The method of aspect 16, wherein determining the one or more carriers in the unlicensed spectrum for sidelink communications between the first UE and the second UE comprises: measuring one or more candidate carriers in the unlicensed spectrum; and selecting a carrier for sidelink communications between the first UE and the second UE based on the measurements.

Aspect 18: The method of aspect 17, wherein measuring the one or more candidate carriers comprises measuring at least one of: an interference level, an energy level, a congestion level, an occupancy level, or a combination thereof of the one or more candidate carriers for the sidelink between the first UE and the second UE.

Aspect 19: The method of any of aspects 16-18, further comprising: re-determining the one or more carriers periodically or based on occurrence of a trigger event; and updating the at least one of: the first UE, the second UE, or both with the re-determined one or more carriers.

Aspect 20: The method of any of aspects 16-19, wherein determining the one or more carriers in the unlicensed spectrum for sidelink communications between the first UE and the second UE comprises: receiving a report including measurements of one or more candidate carriers in the unlicensed spectrum; and selecting a carrier for sidelink communications between the first UE and the second UE based on the measurements.

Aspect 21: The method of any of aspects 16-20, wherein: the node is a base station (BS) and the indication is transmitted on an access link; or the node is a roadside unit (RSU) and the indication is transmitted on a sidelink via a predetermine carrier in an intelligent transport system (ITS) spectrum or is broadcast on all configured carriers.

Aspect 22: An apparatus comprising means for performing the method of any of aspects 1 through 21.

Aspect 23: An apparatus comprising at least one processor and a memory coupled to the at least one processor, the memory comprising code executable by the at least one processor to cause the apparatus to perform the method of any of aspects 1 through 21.

Aspect 24: A computer readable medium storing computer executable code thereon for wireless communications that, when executed by at least one processor, cause an apparatus to perform the method of any of aspects 1 through 21.

### Additional Considerations

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 5 and/or FIG. 8.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communications, comprising:
at least one processor; and
a memory coupled to the at least one processor, the memory comprising code executable by the at least one processor to cause the apparatus to:
determine one or more carriers, from a set of configured carriers, in an unlicensed spectrum to use for communicating with a sidelink user equipment (UE); and
communicate with the sidelink UE using the determined one or more carriers.

2. The apparatus of claim 1, wherein the code executable by the at least one processor to cause the apparatus to determine the one or more carriers, from the set of configured carriers, in the unlicensed spectrum comprises:
code executable by the at least one processor to cause the apparatus to determine the one or more carriers, from the set of configured carriers, based on a carrier hopping rule.

3. The apparatus of claim 2, wherein the carrier hopping rule is common to the apparatus and the sidelink UE.

4. The apparatus of claim 2, wherein the code executable by the at least one processor to cause the apparatus to determine the one or more carriers, from the set of configured carriers, in the unlicensed spectrum comprises code executable by the at least one processor to cause the apparatus to:
determine a first carrier to use for communicating for a first preconfigured duration of activation; and
determine a second carrier to use for a second preconfigured duration of activation, after the first preconfigured duration of activation.

5. The apparatus of claim 4, wherein the preconfigured duration of activation is associated with a carrier index.

6. The apparatus of claim 2, wherein the carrier hopping rule is a function of a time parameter.

7. The apparatus of claim 6, wherein the time parameter comprises a frame number, a subframe number, a slot number, or an absolute time.

8. The apparatus of claim 6, wherein the code executable by the at least one processor to cause the apparatus to determine the one or more carriers, from the set of configured carriers, based on the carrier hopping rule comprises:
code executable by the at least one processor to cause the apparatus to determine one carrier index of one of the configured carriers directly from a mapping of the time parameter to the carrier index.

9. The apparatus of claim 6, wherein the code executable by the at least one processor to cause the apparatus to determine the one or more carriers, from the set of configured carriers, based on the carrier hopping rule comprises:
code executable by the at least one processor to cause the apparatus to determine one carrier index of one of the configured carriers based on a function involving a current frame number, a length of the current frame, and a number of carriers in the set of configured carriers.

10. The apparatus of claim 6, wherein the code executable by the at least one processor to cause the apparatus to determine the one or more carriers, from the set of configured carriers, based on the carrier hopping rule comprises code executable by the at least one processor to cause the apparatus to:
generate a pseudo-random number from the time parameter using the time parameter as an input for a pseudo-random number generator; and
determine a carrier index of one of the configured carriers from the generated pseudo-random number.

11. The apparatus of claim 10, wherein the code executable by the at least one processor to cause the apparatus to generate the pseudo-random number from the time parameter comprises:
code executable by the at least one processor to cause the apparatus to generate the pseudo-random number based on a function of a current frame number and a preconfigured duration of activation.

12. The apparatus of claim 10, wherein the code executable by the at least one processor to cause the apparatus to determine the carrier index of one of the configured carriers from the generated pseudo-random number comprises:
code executable by the at least one processor to cause the apparatus to determine the carrier index based on a function of a current frame number and a number of carriers in the set of configured carriers.

13. The apparatus of any of claim 1, further comprising code executable by the at least one processor to cause the apparatus to:
receive an indication from a node of the one or more carriers, wherein
determine the one or more carriers, from the set of configured carriers, in the unlicensed spectrum comprises determining the one or more carriers based on the indication from the node.

14. The apparatus of claim 13, further comprising code executable by the at least one processor to cause the apparatus to:
measure one or more candidate carriers between the apparatus and the sidelink UE in the unlicensed spectrum; and
report the measurements to the node, wherein the indication of the one or more carriers from the node is received in response to the reporting.

15. The apparatus of claim 13, wherein:
the node is a base station (BS) and the indication is received on an access link; or
the node is a roadside unit (RSU) and the indication is received on a sidelink via a predetermined carrier in an intelligent transport system (ITS) spectrum or is broadcast on all of the configured carriers.

16. An apparatus for wireless communications, comprising:
at least one processor; and
a memory coupled to the at least one processor, the memory comprising code executable by the at least one processor to cause the apparatus to:
determine one or more carriers in an unlicensed spectrum for sidelink communications between at least a first user equipment (UE) and a second UE; and
transmit an indication of the one or more carriers to at least one of the first UE, the second UE, or both.

17. The apparatus of claim 16, wherein the code executable by the at least one processor to cause the apparatus to determine the one or more carriers in the unlicensed spectrum for sidelink communications between the first UE and the second UE comprises code executable by the at least one processor to cause the apparatus to:
measure one or more candidate carriers in the unlicensed spectrum; and
select a carrier for sidelink communications between the first UE and the second UE based on the measurements.

18. The apparatus of claim 17, wherein the code executable by the at least one processor to cause the apparatus to measure the one or more candidate carriers comprises:
code executable by the at least one processor to cause the apparatus to measure at least one of: an interference level, an energy level, a congestion level, an occupancy level, or a combination thereof of the one or more candidate carriers for the sidelink between the first UE and the second UE.

19. The apparatus of claim 16, further comprising code executable by the at least one processor to cause the apparatus to:
re-determine the one or more carriers periodically or based on occurrence of a trigger event; and
update the at least one of: the first UE, the second UE, or both with the re-determined one or more carriers.

20. The apparatus of claim 16, wherein the code executable by the at least one processor to cause the apparatus to determine the one or more carriers in the unlicensed spectrum for sidelink communications between the first UE and the second UE comprises code executable by the at least one processor to cause the apparatus to:
receive a report including measurements of one or more candidate carriers in the unlicensed spectrum; and
select a carrier for sidelink communications between the first UE and the second UE based on the measurements.

21. The apparatus of claim 16, wherein:
the apparatus is a base station (BS) and the indication is transmitted on an access link; or
the apparatus is a roadside unit (RSU) and the indication is transmitted on a sidelink via a predetermine carrier in an intelligent transport system (ITS) spectrum or is broadcast on all configured carriers.

22. A method for wireless communications by a first sidelink user equipment (UE), comprising:
determining one or more carriers, from a set of configured carriers, in an unlicensed spectrum to use for communicating with a second sidelink UE; and
communicating with the second sidelink UE using the determined one or more carriers.

23. The method of claim 22, wherein the determining the one or more carriers, from the set of configured carriers, in the unlicensed spectrum comprises:
determining the one or more carriers, from the set of configured carriers, based on a carrier hopping rule.

24. The method of claim 23, wherein the carrier hopping rule is common to the first sidelink UE and the second sidelink UE.

25. The method of claim 23, wherein the carrier hopping rule is a function of a time parameter.

26. The method of claim 25, wherein determining the one or more carriers, from the set of configured carriers, based on the carrier hopping rule comprises:
determining one carrier index of one of the configured carriers directly from a mapping of the time parameter to the carrier index.

27. The method of claim 25, wherein determining the one or more carriers, from the set of configured carriers, based on the carrier hopping rule comprises:
determining one carrier index of one of the configured carriers based on a function involving a current frame number, a length of the current frame, and a number of carriers in the set of configured carriers.

28. The method of claim 22, further comprising:
receiving an indication from a node of the one or more carriers, wherein
determining the one or more carriers, from the set of configured carriers, in the unlicensed spectrum comprises determining the one or more carriers based on the indication from the node.

29. The method of claim 28, further comprising:
measuring one or more candidate carriers between the first sidelink UE and the second sidelink UE in the unlicensed spectrum; and
reporting the measurements to the node, wherein the indication of the one or more carriers from the node is received in response to the reporting.

30. A method for wireless communications by a node, comprising:
determining one or more carriers in an unlicensed spectrum for sidelink communications between at least a first user equipment (UE) and a second UE; and
transmitting an indication of the one or more carriers to the first UE, the second UE, or both.
